(19) United States
(12) Patent Application Publication
(10) Pub. No.: US 2006/0183485 A1
(43) Pub. Date: Aug. 17, 2006

(54) Location system and wireless base station

(76) Inventors: Kenichi Mizugaki, Kokubunji (JP); Ryosuke Fujiwara, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/335,516

(22) Filed: Jan. 20, 2006

(30) Foreign Application Priority Data
Feb. 16, 2005 (JP) 2005-038568

(51) Int. Cl. H04Q 7/20

(52) U.S. Cl. 455/456.1

(57) ABSTRACT

In the conventional wireless location system that synchronizes base stations by wireless communication, waveforms of a signal used for synchronization and of a signal used for delay measurement are the same, and therefore if there is a reflected wave in an earlier-sent signal, it becomes difficult to distinguish two kinds of signals, and accordingly location accuracy suffers degradation. Moreover, when two different waveforms are allocated to the two signals, a matched filter that supports the two waveforms becomes necessary, which inevitably makes a circuit size large. The invention is characterized in that signals having the same waveform but having different polarities are allocated to the synchronizing signal and the signal for delay measurement, respectively. This enables the two kinds of signals to be detected with one matched filter and also to be distinguished by simple means using polarity difference.

### CLAIM OF PRIORITY

The present application claims priority from Japanese application JP 2005-038568 filed on Feb. 16, 2005, the contents of which is hereby incorporated by reference into this application.

### FIELD OF THE INVENTION

This invention relates to a wireless base station of a location system that measures a position of a node having a function of wireless transmission, and a wireless base station of the system.

### BACKGROUND OF THE INVENTION

A concept of the sensor network that information collected by a small sensor terminal (node) is sent to a server through a wireless network is making substantial progress toward utilization in recent years by development of a circuit miniaturization technology using MEMS etc. and advent of new wireless communication systems.

Although these small sensor nodes that eliminate the need for connection with cable are very flexible in terms of installation and operations, on the other hand, they need a technology of measuring positions of the sensors in order to specify a position where abnormality occurred. A typical method as the conventional node location method is methods of measuring a position using a signal from satellites, such as a GPS. However, these methods have a problem that they can only be used out-of-doors where radio waves from satellites are receivable and that they need an exclusive receiver and antenna, which makes the node large. As a location method that can be used indoors, there is a method in which a waveform of a radio wave transmitted from a node is recorded, a received timing of the signal is determined, and a node position is calculated from measurement results of received timings of a plurality of base stations (JP-A No. 189353/2003 (Patent document 1)). In order to acquire high location accuracy by this method, it is required to measure accurately received times of two kinds of signals, a synchronizing signal and a signal for delay measurement.

### SUMMARY OF THE INVENTION

In the conventional technology, since the signal used for obtaining a delay from the node to a base station and a signal used for synchronization between base stations are the same in waveform, if there exists a reflected wave for a signal being sent earlier, it becomes difficult to distinguish the two kinds of signals and accordingly location accuracy suffers degradation. Alternatively, if different waveforms are allocated to the two signals, there is a problem that a matched filter (MF) supporting two waveforms become necessary on the receiving side, and accordingly the circuit size becomes large.

This invention is characterized in that two signals having the same waveform but having different polarities from each other are allocated to a synchronizing signal and a signal for delay measurement both of which are necessary to perform the location. The base station that receives the synchronizing signal and the signal for delay measurement enters the two kinds of input signals into the same matched filter, and calculates a correlation value for the same signal sequence. Since the two kinds of input signals have the same waveform, they can be detected by the matched filter using the same signal sequence, and the two signal outputs can be distinguished because of polarity difference of outputs. Timings at which the absolute value of this matched filter output becomes maximums in both polarities are detected as a received timing of the synchronizing signal and a received timing of the signal for delay measurement, respectively. For the matched filter here, both an analog filter and a digital filter are usable without causing any problem. In the case of a digital filter, a signal from an RF part is A/D converted before entering the filter and the matched filter output, as it is, is recorded in the memory. In the case of an analog filter, the signal from the RF part, as it is, is entered into the matched filter and its output is A/D converted and recorded in the memory.

By allocating the signals having the same waveform but having different polarities from each other to the synchronizing signal and the signal for delay measurement, it becomes possible to detect the two kinds of signals with one MF and also distinguish the two signals easily by polarity difference.

### BRIEF DESCRIPTION OF THE DRAWINGS

FIG. 1 is a configuration diagram of a location system of a first embodiment of this invention;

FIG. 2 is one example of a signal waveform of the first embodiment of this invention;

FIG. 3 is a block diagram showing a position calculation flow of the first embodiment of this invention;

FIG. 4 is a diagram of a message flow of the first embodiment of this invention;

FIG. 5 is a block diagram of a reference station of the first embodiment of this invention;

FIG. 6 is a block diagram of a base station of the first embodiment of this invention;

FIG. 7 is a block diagram of a received timing measurement section of the first embodiment of this invention;

FIG. 8 is a block diagram of a location system of a second embodiment of this invention;

FIG. 9 is a block diagram showing a position calculation flow of the second embodiment of this invention; and

FIG. 10 is a configuration diagram of a base station of the second embodiment of this invention.

### DETAILED DESCRIPTION OF THE PREFERRED EMBODIMENTS

### First Embodiment

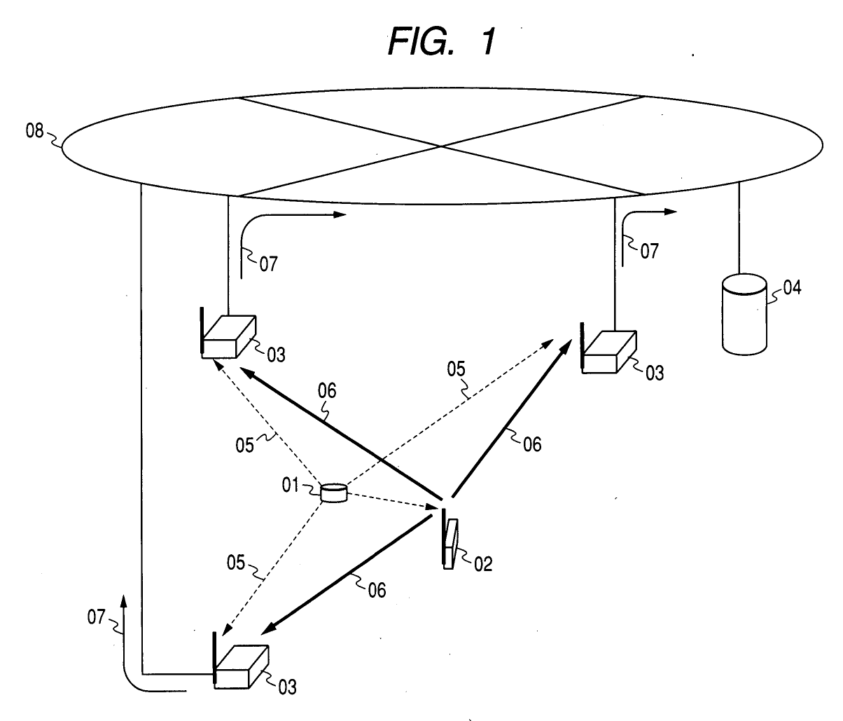

A first embodiment of this invention will be described with reference to drawings. FIG. 1 is a configuration diagram of a location system of the first embodiment of this invention. A node 01 is equipped with a function of transmitting a positioning signal 05 composed of a pulse or a pulse train. A reference station 02 is equipped with a function of transmitting a reference signal 06 for determining a reference time by wireless communication after receiving a signal from the node 01. At this time, a reference signal shall be a pulse or a pulse train of the positioning signal transmitted from the node 01 whose polarity is inverted. Each base station 03 receives the positioning signal 05 transmitted by the node 01 and the reference signal 06 transmitted by the reference station 02, and enters the received signals into a common matched filter (MF). Since the positioning signal 05 and the reference signal 06 have the same waveform but have inverted polarities to each other, the MF can detect both the positioning signal and the reference signal and obtain two outputs whose polarities are different. The base station 03 records the two outputs. The base station 03 obtains received times of the two signals from the MF outputs. A server 04 has information of coordinates of each of the base stations 03, and is connected with each of the base stations 03 through a network 08. The server 04 calculates a difference between the positioning signal received time and the reference signal transmitting time from received time information 07 that is information of signal reception times of the positioning signal and the reference signal both of which were obtained from each of the base stations through the network 08 and information on a distance between each of the base stations and the reference station, and calculates a position of the node 01 based on the information of the time difference and information of coordinates of each of the base stations 03. In the case where position detection of the node is performed using a system in which base stations are not guaranteed to operate in synchronization, it is necessary to compensate an operation timing error between the base stations in some way. In this embodiment, a received timing of the reference signal 06 transmitted from the reference station 02 in a known position (or a distance from each of the base stations 03 is known) at the base station 03 whose position is known is measured, and by postulating that a shift of the received timing of the reference signal 06 resulting from a state where the base stations are asynchronous with one another affects the received timing of the positioning signal 05 similarly, the operation timing error between base stations is compensated.

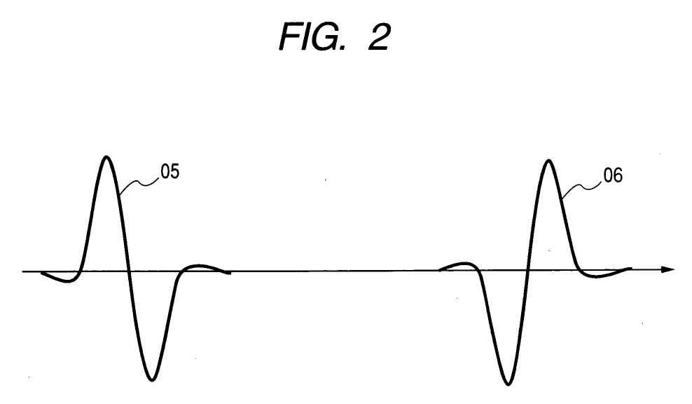

FIG. 2 shows one example of temporal waveforms of the positioning signal 05 and the reference signal 06 in the case where a UWB (Ultra Wide band) pulse signal is used. It is assumed that the reference signal has the same waveform as the positioning signal and the polarity of the whole signal is inverted to it.

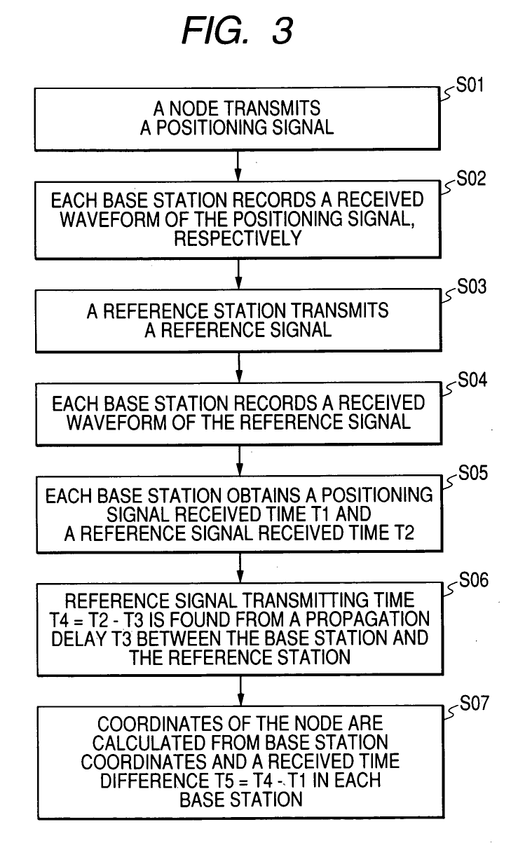

FIG. 3 shows a position calculation flow in this invention. First, the node 01 that is an object of the location transmits the positioning signal 05 towards the base station 03 and the reference station 02 (Step S01). As a trigger of transmitting of this positioning signal, for example, there is a method for transmitting a signal for every fixed interval based on a timer attached to the node 01. Moreover, as another example, there is also a method in which the node 01 transmits the positioning signal 05 in response to the positioning signal transmission instruction from the base station 03. Alternatively, variation in sensor information or a fact that a residual amount of buffer for storing sensor information falls below a threshold may be used as a trigger to transmit the positioning signal.

Each of the plurality of base stations 03 capable of receiving a signal from the node 01 enters the positioning signal 05 transmitted from the node 01 into its MF and records an output waveform from the MF (Step S02). As an example of selection and adjustment of an MF to the input signal, there is a method in which positioning signal waveforms exclusively for each of a plurality of communication channels that the communication system can use are previously set up, and each base station has MFs that support the positioning signal waveforms of all the channels, respectively, enters the received signal into all the MFs, and adopts an MF that yields a maximum output. As long as the positioning signal 05 and the reference signal 06 have the same waveform, both a lone pulse and a pulse train are usable without causing any problem. Note that the MF shall support each signal; if the signal is a pulse train, the MF shall support the pulse train.

The reference station 02 checks the positioning signal 05 from the node 01 has been received using the same MF as that of each of the base stations 03. Then, the reference station 02 transmits the reference signal 06 to the surrounding base stations 03 (Step S03). The reference signal 06 shall have the same waveform as the positioning signal 05 at the time of being transmitted from the node but have the inverted polarity to the positioning signal 05. At this time, the reference signal 06 with the above-mentioned waveform may be stored in advance in the reference station 02, or the system can use a method for recording the waveform of the positioning signal 05, generating a reference signal whose polarity is inverted to the received waveform, and transmitting it to the base station. There is a method which comes under the scope of this invention in which the reference station 02 transmits the reference signal 06 when a fixed offset time elapsed in order to prevent the reference signal 06 from coinciding with a reflected wave of the positioning signal 05 transmitted from the node 01 at the time of transmitting the reference signal 06. The base station 03 that received the signal of the reference station 02 enters also the reference signal 06 to the MF as in the case of the positioning signal 05 and records the reference signal together with the output waveform of the positioning signal 05 (Step S04).

Each base station obtains a received time T1 of the positioning signal and a received time T2 of the reference signal from the output waveform of the MF (Step S05). As a method for detecting received times of the positioning signal and the reference signal, there is a method for obtaining times at which a maximum and a minimum of the MF output waveform to be recorded are received. Since the MF outputs of the positioning signal and the reference signal become opposite in polarity, if the MF shows a maximum at the time of receiving the positioning signal, the MF will show a minimum at the time of receiving the reference signal. On the contrary, if the MF shows a minimum at the time of receiving the positioning signal, the MF will show a maximum at the time of receiving the reference signal.

If a signal with a polarity opposite to that of the earlier-received signal cannot be found, it is considered that either the positioning signal or the reference signal suffered signal polarity inversion on the way of a propagation path. As a method effective in the case where an opposite-polarity signal was not received in this way, there is a method in which a previously set-up threshold A for the absolute value of a signal amplitude is determined, the positioning signal and the reference signal are selected from signals whose amplitudes exceed A, and received times of these signals are obtained. As a method for selecting each signal, for example, there is a method in which first a signal whose amplitude is largest is selected and, after excluding signals whose received times are very close to that of the signal and that are considered as reflected waves, a signal whose amplitude is second largest is selected. Then, one of the two signals whose received time is earlier is determined as the positioning signal and the other whose received time is later is determined as the reference signal.

Each of the base stations 03 sends to the server 04 the received time information 07 that includes several pieces of information: the positioning signal received time T1, the reference signal received time T2, an identifier of each of the base stations, an identifier of the node having sent the positioning signal, an identifier of the reference station having sent the reference signal, etc. As a method for acquiring the identifier information of the node and the reference station, there is a method in which after the node 01 sent the positioning signal 05 or after the reference station 02 sent the reference signal 06, the node 01 or reference station 02 sends information including a fact that the signal was sent a little while ago and its identifier; if there did not come similar information from other node 01 or reference station 02 within a fixed period after receiving the positioning signal 05 or reference signal 06, the base station 03 adopts that identifier; and if similar information was sent from one of a plurality of nodes 01 or reference stations 02, one node 01 or reference station 02 among them is designated and instructed to send the positioning signal 05 or reference signal 06 again.

Based on information on the reference signal detected time T2 included in the received time information 07 sent from each of the base stations 03 and the known propagation delay T3 that is elapsed for the signal to propagate between the reference station and the base station, a reference signal transmitting time T4=T2−T3 at which the reference station transmitted the reference signal is obtained and designated as a reference time common to all the base stations (Step S06).

Next, a difference T5=T1−T4 between the reference signal transmitting time T4 and the positioning signal received time T1 is obtained. Coordinates of the node 01 are calculated by the hyperbola intersection method using this information and coordinates of each base station (Step S07). Incidentally, calculation procedures of calculating a position are described in detail in Patent document 1.

Moreover, a method in which collision of a reflected wave of the positioning signal and the reference signal in the base station 03 is avoided by inserting a fixed offset time that extends until the reference station 02 transmits the reference signal 06 after the reception of the positioning signal 05 from the node 01 also comes under the scope of this invention. In this case, the base station 03 can achieve reduction in power consumption, reduction in a size of memory, etc. by halting received timing measurement of signals for a period corresponding to an offset time after receiving the positioning signal 05.

In addition, as a method for measuring a received timing, there is also a method in which direct waveforms of the positioning signal and the reference signal are searched and their received times are used, in addition to the method for simply using times at which the MF output becomes a maximum and a minimum, respectively. As a method for searching a direct wave, for example, there is a method of doing the following procedures. Two thresholds, a threshold B having a small absolute value and a threshold C having a large absolute value, are set up for polarity of either +1 or (−1), respectively; the received signal is determined surely as a desired signal at a time when the amplitude of the received signal exceeds the amplitude threshold C; assuming that the direct wave came earlier than that time point, the amplitude of the received signal earlier than the time point when the signal exceeded the threshold C is examined until the absolute amplitude becomes smaller than the threshold B; and by using a time at which the amplitude falls below the threshold B as a reference, an incoming time of the direct wave is estimated. Details of this method for measuring a received timing is disclosed in JP-A No. 014152/2002.

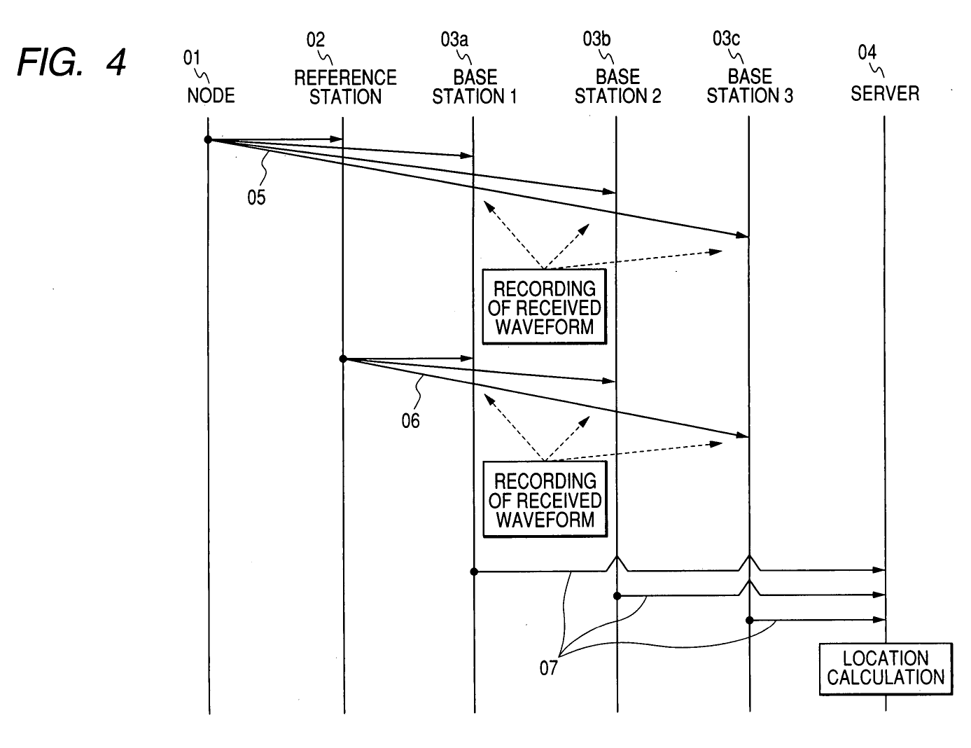

FIG. 4 shows one example of a message flow in this invention. The node 01 transmits the positioning signal 05 at an arbitrary timing to the surrounding base stations (03a-03c) and the reference station 02, and each base station records the MF output waveforms of the signal, respectively. Next, the reference station that received the positioning signal 05 transmits the reference signal 06, and each of the base stations 03 records similarly an MF output waveform of the reference signal 06 from the reference station. Each base station obtains a received time of the positioning signal and a received time of the reference signal, respectively, and sends the received time information 07 including information of its identifier used for identifying the base station etc. to the server 04.

The server 04 estimates the signal transmitting time of the reference station from information on the received time of the reference signal included in the received time information 07 and a propagation delay from each of the base stations to the reference station that the server has. At this time, it also comes under the scope of this invention that the contents of the received time information that the base station sends to the server is a difference between the received time of the reference signal and the received time of the positioning signal and the server calculates a difference between the received time of the positioning signal and a transmitting time of the reference signal.

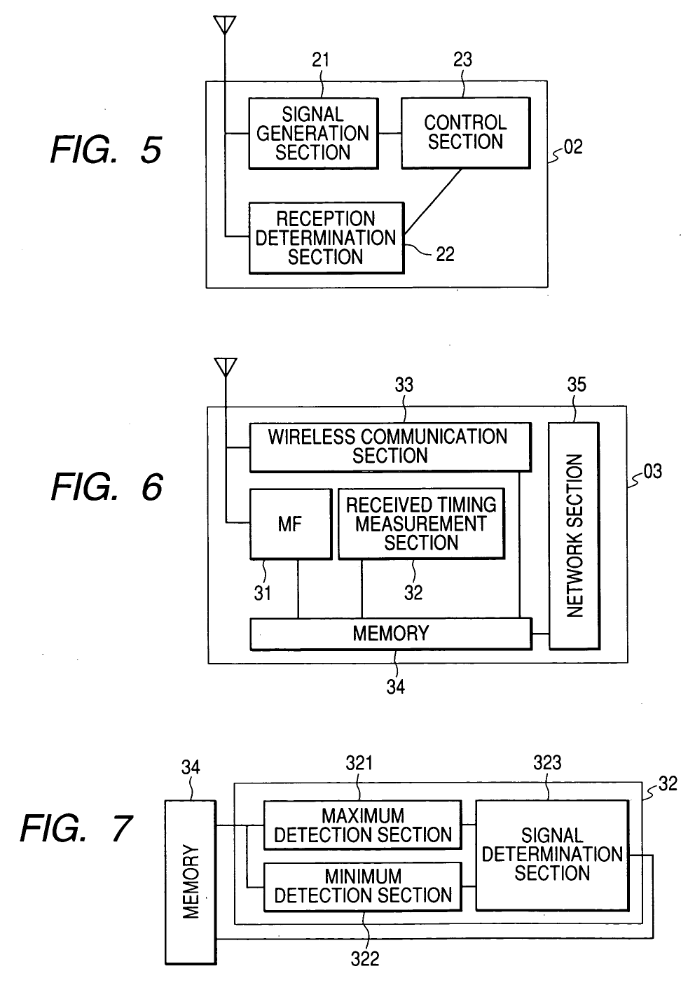

FIG. 5 shows a configuration of the reference station in this invention. The reference station 02 consists of a signal generation section 21 for generating two signals of the two kinds of polarities, positive and negative, a reception determination section 22, and a control section 23 in addition to an RF part including an antenna. When the reference station 02 received a signal, first the reception determination section 22 determines whether the received signal is the positioning signal 05. If it is the positioning signal 05, its waveform is stored and its polarity is determined. As a method for determining the positioning signal 05, there is a method in which a plurality of MFs that support signals that are expected to be received are set up in advance, and a signal whose MF output is largest for the received signal is selected. When reception of the positioning signal 05 was checked, the control section 23 instructs the signal generation section 21 to generate the reference signal 06 having the same waveform as the stored waveform but having the inverted polarity to it, and a signal transmission timing. Regarding the timing of signal transmission, there is a method for transmitting the signal when a fixed offset time elapsed after the reception, in addition to the method for transmitting the signal immediately after the reception. The signal generation section 21 generates the reference signal 06, and transmits the signal at a timing instructed by the control section 23.

Moreover, a method in which a signal whose polarity is opposite to a signal that the node 01 transmits is stored in advance and is transmitted as a reference signal permanently, regardless of a polarity of the waveform that the signal generation section 21 received, also comes under the scope of this invention. In this case, it is recommended that, when the positioning signal was received as with a polarity opposite to the normal case, the reference signal be also transmitted as with a polarity opposite to the normal case.

FIG. 6 shows a configuration of the base station 03 in this invention. The base station 03 has: an MF 31 that supports waveforms of the reference signal and the positioning signal; a received timing measurement section 32 for measuring received timings of signals of the positioning signal, the reference signal, etc.; a wireless communication section 33 for performing usual wireless communication with the node etc.; memory 34 in which signal received timings and information obtained by communication are recorded; and a network section 35 for controlling communication to the server; in addition to the RF part including the antenna. Taking a signal sent from the RF part as an input, the MF 31 performs the sliding correlation processing with a previously determined signal sequence and outputs its results. At this time, a method in which the MF uses a signal sequence corresponding to an ID designated to each terminal as a signal sequence that the MF uses in correlation calculation, in addition to a specially determined signal sequence for the location, is one realization method for this invention. In either case, a signal from the base station and a signal from the reference station are entered into the same MF and used to calculate a correlation value with the same signal sequence. For the MF 31 in this stage, an analog filter and a digital filter are usable without causing any problem. In the case of a digital filter, a signal from the RF part is A/D converted before entering it into a filter and an MF output, as it is, is recorded in the memory 34. In the case of an analog filter, a signal from the RF part, as it is, is entered into the MF 31, and its output is A/D converted and recorded in the memory 34.

The base station enters a signal received by the RF part into the MF 31, and monitors the reception of the positioning signal 05. As a method for determining the reception of the positioning signal 05, for example, the reception is determined by whether the absolute value of the amplitude of the MF 31 output exceeds a fixed threshold. When the reception of the positioning signal is checked, the MF 31 output, as it is, is sent to the memory 34 and the MF 31 output waveforms for the positioning signal 05 and the reference signal 06 are recorded. The received timing measurement section 32 obtains the received times of the positioning signal 05 and the reference signal 06 from the MF outputs stored in the memory 34, and records the results in the memory 34. The network section 35 sends to the server information of those signal received times and information on the identifiers of the node and the reference station. In the system where the reference station 02 inserts an offset time of a fixed interval between the reception of the positioning signal 05 and the transmission of the reference signal 06, there can be used a method in which, when the amplitude of the output exceeded a fixed value, reception of the positioning signal 05 is determined, and writing of the MF output into the memory is halted for a time corresponding to the offset interval, whereby the memory quantity being used is curtailed.

FIG. 7 shows one example of a configuration of the received timing measurement section. The received timing measurement section 32 consists of a maximum detection section 321, a minimum detection section 322, and a signal determination section 323, wherein the maximum detection section-321 and the minimum detection section 322 obtain a maximum and a minimum of the MF output stored in the memory 34 and reception times of these signals, respectively. The signal determination section 323 compares signal received times obtained from the maximum detection section 321 and from the minimum detection section 322, sets an earlier received signal as a positioning signal and a later received signal as a reference signal, respectively, and records them together with their received times in the memory.

For the received timing measurement section, in addition to one that uses a method for determining a maximum like this, one that has a function of estimating a received time of a direct wave by setting a time at which the amplitude of a received signal exceeds a threshold as a reference and searching a rise of the signal waveform is conceivable. Alternatively, there is a method where, if the reception of a signal whose polarity is opposite to that of the received signal cannot be checked, it is assumed that polarity inversion occurred in the propagation path, times at which large amplitude signals were detected are obtained among the MF outputs, and the received time of the positioning signal and the reference signal are obtained therefrom.

### Second Embodiment

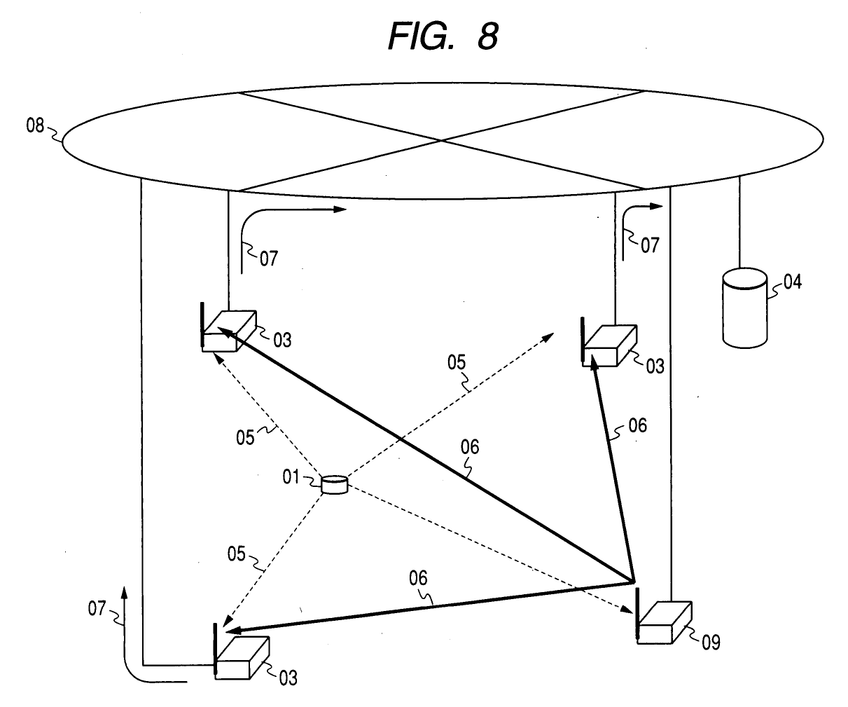

FIG. 8 is a configuration diagram of a location system of a second embodiment of this invention. The node 01 is equipped with a function of transmitting the positioning signal 05 composed of a pulse or a pulse train. A base station 09 with a reference signal transmitting function is equipped with a function of transmitting the reference signal 06 used for fixing the reference time by wireless communication after receiving the positioning signal 05 from the node 01. At this time, the reference signal shall be a pulse or a pulse train of the positioning signal transmitted from the node 01 whose polarity was inverted. The base station 03 receives the positioning signal 05 transmitted by the node 01 and the reference signal 06 transmitted by the base station 09, and enters the received signals into a common matched filter (MF). Since the positioning signal 05 and the reference signal 06 have the same waveform but have inverted polarities to each other, the MF detects both the positioning signal 05 and the reference signal 06, obtaining two outputs whose polarities are different. The server 04 has information on coordinates of each of the base stations 03, and is connected with each of the base stations 03 through the network 08. The server 04 calculates a difference between the positioning signal received time and the reference signal transmitting time from the received time information 07 on the positioning signal 05 obtained from each of the base stations 03 through the network 08 and the reference signal 06 and information on a propagation delay between each of the base stations and the reference station that the server has in advance, and then calculates a position of the node 01 based on the information of the time difference and information of coordinates of each of the base stations.

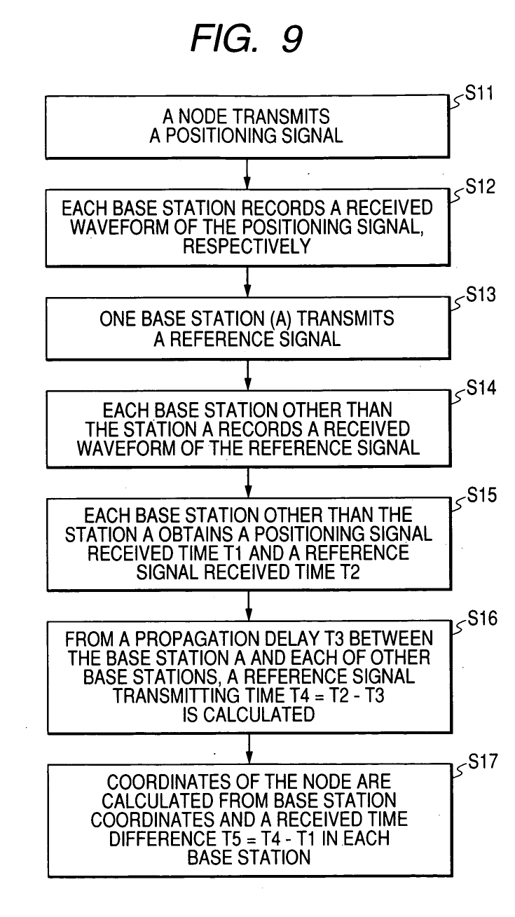

FIG. 9 shows a position calculation flow of the second embodiment of this invention. First, the node 01 that is a target of the location transmits the positioning signal 05 to the base stations 03 and 09 (Step S11). Each of the plurality of base stations 03 and 09 capable of receiving the signal of the node 01 enters the positioning signal 05 sent from the node 01 into its MF and records an output waveform from the MF (Step S12).

The base station 09 with the reference signal transmitting function transmits the reference signal 06 to the base station 03 that received the positioning signal 05, after receiving the positioning signal 05 from the node 01 (Step S13). The base station 09 records the reference signal transmitting time. The reference signals 06 shall be a signal whose waveform is the same as the waveform of the positioning signal 05 at the time of being transmitted from the node 01 but whose polarity is inverted to the positioning signal 05. At this time, it is also possible to adopt a method in which a waveform of the positioning signal 05 is recorded, and a reference signal that is a received waveform whose polarity is inverted thereto is generated and transmitted to the base station.

The base station 03 that received the signal of the base station 09 enters the reference signal 06 into its MF similarly as in the case of the positioning signal 05 and records the MF output together with the output waveform of the positioning signal (Step S14). Each of the base stations 03 obtains a difference between the positioning signal received time T1 and the reference signal received time T2 from the output waveform of its MF (Step S15).

Each of the base stations 03 sends the received time information 07 including information of the positioning signal received time T1, the reference signal received time T2, the identifier of each of the base stations, an identifier of a node that sent the positioning signal, an identifier of the base station that sent the reference signal, etc. to the server 04. As a method for acquiring identifier information of the node 01 and the base station 09, there is a method in which, after the node 01 sent the positioning signal 05 or after the base station 09 sent the reference signal 06, the node 01 or base station 09 sends information of a fact that the signal was sent a little while ago and its identifier to the base station 03. If there does not come similar information from other node 01 and base stations 09 within a fixed time after receiving the positioning signal 05 or the reference signal 06, the base station 03 adopts the identifier, if there was sent similar information from the plurality of nodes 01 and base stations 090, one of the nodes 01 or base stations 090a is designated and instructed to send the positioning signal 05 or the reference signal 06 again.

The server 04 calculates the coordinates of the node 01 that sent the positioning signal 05 based on the received time information 07 sent from each of the base stations 03 and known coordinates of each of the base stations (03 and 09). For the received time information 07 sent from each of the base stations (03 and 09), the server obtains the reference signal transmitting time T4=T2−T3 when the reference-signal-transmitting base station sent the reference signal based on the reference signal detected time T2 and a known propagation delay T3 that is elapsed for the signal to propagate between the reference-signal-transmitting base station 09 and the base station in concern (Step S16).

Next, a difference T5=T1−T4 between the reference signal transmitting time T4 and the positioning signal received time T1 is calculated. In this stage, regarding also the base station 09 having transmitted the reference signal 06, a difference between the reference signal transmitting time T4 and the positioning signal received time T1 of the base station is obtained. Using these pieces of information and coordinates of each of the base stations, the coordinates of the node 01 is calculated by the hyperbola intersection method (Step S17).

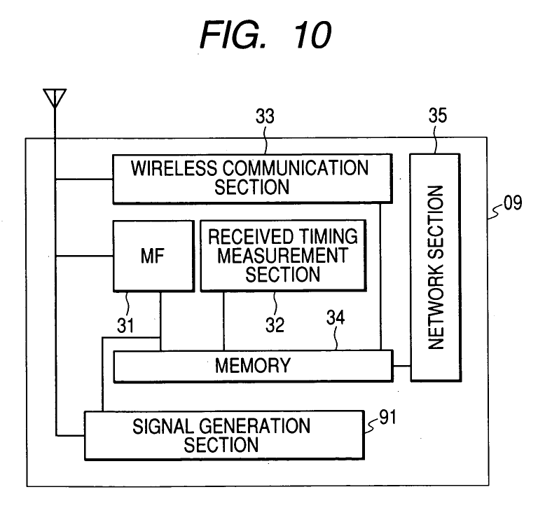

FIG. 10 shows a configuration of a base station 09 with the reference signal transmitting function in this invention. The base station 09 has: the MF 31 that supports the waveforms of the reference signal and the positioning signal; the received timing measurement section 32 for measuring received timings of signals of the positioning signal and the reference sign transmitted from other base station, etc.; the wireless communication section 33 for performing usual wireless communication with the node 01 etc.; the memory 34 for recording a signal received timing and information obtained by communication; a signal generation section 91 for generating two signals of the two kind of polarities, positive and negative; and the network section 35 for controlling communications to the server; in addition to the RF part including the antenna.

The base station enters a signal received by the RF part into the MF 31 and monitors the reception of the positioning signal 05. As a method for determining whether the positioning signal was received, for example, there is a method for determining it by checking whether an absolute value of the amplitude of the MF output exceeded a fixed threshold. When the reception of the positioning signal 05 was checked, the MF output is recorded in the memory 34, and the signal generation section 91 transmits the reference signal 06. At this time, inserting a fixed offset interval between the reception of the positioning signal and the transmission of the reference signal also comes under the scope of this invention. The received timing measurement section 32 obtains a received time of the positioning signal 05 from the MF output recorded in the memory, and records the received time in the memory together with the transmitting time of the reference signal 06. The network section 35 sends to the server 04 information of the received time of the positioning signal, the transmitting time of the reference signal, an identifier of the received node, and a fact that the network section 35 sent the reference signal.

Since the application of the technology of this invention to a wireless location system can reduce the number of matched filters necessary in the base station, the invention can realize miniaturization and lower cost of the base station. Moreover, since the processing on the matched filter outputs is simple, such as detection of a maximum value and a minimum value, the technology of this invention is expected to shorten a calculation time necessary for the location and make smaller the power consumption of the base station.

What is claimed is:

1. A wireless location system for measuring a position of a node using a wireless communication system that has a node equipped with a wireless function, a plurality of base stations, and at least one reference station,
wherein the system calculates a position of the node based on received times of a positioning signal from the node and of a reference signal from the reference station whose distance from each of the base stations or position is known,
the positioning signal and the reference signal are two kinds of signals having the same waveform but having inverted polarities to each other, and
the base station detects the positioning signal and the reference signal using the same matched filter and distinguishes the two signals by means of change of polarity of the matched filter output.

2. The wireless location system according to claim 1,
wherein, if difference of polarity was not observed in distinguishing the two kinds of signals, the system sets up a threshold for an absolute value of an amplitude of the matched filter output and selects the two kinds of signals among signals exceeding the threshold.

3. The wireless location system according to claim 1,
wherein the reference station has the same function as the base station, and at the time of not performing the location, it operates as a usual base station, whereas at the time of performing the location, it measures a received time of the positioning signal from the node and a transmitting time of the reference signal that the reference station transmitted, and informs the server of the received time and the transmitting time.

4. The wireless location system according to claim 2,
wherein the reference station has the same function as the base station, and at the time of not performing the location, it operates as a usual base station, whereas at the time of performing the location, it measures a received time of the positioning signal from the node and a transmitting time of the reference signal that the reference station transmitted and informs them to the server.

5. A base station in a wireless location system that comprises a node having a function of wireless communication, a plurality of base stations, and at least one reference station and measures a position of the node by calculating the position of the node based on received times of a positioning signal from the node and of a reference signal from the reference station whose distance from each of the base stations or position is known that are received by each of the base stations, comprising:
a matched filter that supports waveforms of the two kinds of signals;
a received timing measurement section that determines received timing of the positioning signal and the reference signal using the matched filter output; and an output section that outputs the received timing of the positioning signal and the reference signal both so determined;
wherein the positioning signal and the reference signal are two kinds of signals having the same waveform but having inverted polarities to each other, and the received timing measurement section distinguishes the two kinds of signals by polarity change of the matched filter output.

6. The base station of a wireless location system according to claim 5,
wherein the system has a function of, if difference of polarity was not observed in distinguishing the two kinds of signals, setting up a threshold for an absolute value of the amplitude of the matched filter output and selecting the two kinds of signals among signals whose amplitudes exceed the threshold.

7. The base station according to claim 5,
wherein the system has a function of transmitting a signal to be used to synchronize the base stations to surrounding base stations and has a function of measuring, at the time of performing the location, a received time of the signal from the node and a transmitting time of the synchronizing signal between base stations that the base station transmitted and informing the server of the received time and the transmitting time.

8. The base station according to claim 6,
wherein the system has a function of transmitting a signal to be used to synchronize the base stations to the surrounding base stations and has a function of measuring, at the time of performing the location, a received time of the signal from the node and a transmitting time of the synchronizing signal between base stations that the base station itself transmitted and informing the server of the received time and the transmitting time.
